(19) United States
(12) Patent Application Publication
(10) Pub. No.: US 2021/0161124 A1
(43) Pub. Date: Jun. 3, 2021

(54) METHOD AND DEVICE FOR DISTRIBUTING BENEFICIAL ARTHROPODS

(71) Applicant: PIONEER HI-BRED INTERNATIONAL, INC., JOHNSTON, IA (US)

(72) Inventors: RYAN KRULL, ANKENY, IA (US); ROSS MEGARGEL, DENVER, CO (US)

(73) Assignee: PIONEER HI-BRED INTERNATIONAL, INC., JOHNSTON, IA (US)

(21) Appl. No.: 15/734,374

(22) PCT Filed: Jun. 14, 2019
(86) PCT No.: PCT/US19/33461

§ 371 Date: Dec. 2, 2020

Related U.S. Application Data
(60) Provisional application No. 62/681,250, filed on Jun. 6, 2018.

(51) Int. Cl. A01M 99/00; A01N 63/10; A01K 67/033

(52) U.S. Cl. CPC A01M 99/00; A01K 67/033; A01N 63/10

(57) ABSTRACT

A method and apparatus for distributing beneficial arthropods to plants. The method and apparatus include a temperature control system for maintaining the beneficial arthropods at an optimal temperature prior to dispersal and a pneumatic system for conveying the beneficial arthropods.

### FIELD OF THE INVENTION

The present invention relates to devices and methods for distributing beneficial arthropods to plants.

### BACKGROUND OF THE INVENTION

Beneficial arthropods may be used in agriculture for biological pest control. To perform their function, such beneficial arthropods must be distributed (dispersed) on the plants. This is often done by manually dispersing the beneficial arthropods on the plants, which is labor-intensive. To provide a saving of labor while distributing beneficial arthropods, devices such as WO2007136246 and DE4424499 have been described.

WO2007136246 describes a device with fans and blowers that distribute the beneficial arthropods. The device uses an auger to position the beneficial arthropods into the airflow stream of a blower/fan, which does not result in a precisely measured amount of arthropods applied per period of time or precise application. In addition to this lack of precision, the operation of the device requires the storage of beneficial arthropods at the temperatures often found within a controlled environment, which are too warm for convenient storage of large volumes of beneficial arthropods.

DE4424499 describes a device in which beneficial arthropods may be dispersed by being carried on the back of a person, like a leaf blower, which requires a considerable amount of human labor and can result in imprecise distribution.

What is needed is a device that can deliver a precise application of beneficial arthropods to plants in an automated manner, and optionally, that can store such beneficial arthropods at a controlled temperature and in a homogeneous mixture within the carrier prior to application.

### SUMMARY OF THE INVENTION

Beneficial arthropods may be used on plants to control pests and may reduce or limit the amount of pesticides or fungicides applied. They may be used in any environment, but use in a controlled environment is particularly desirable because the application of chemical pesticides and fungicides in a controlled environment requires following proscribed procedures that may involve the need for protective gear or a delayed re-entry period of the room or chamber for worker protection.

The beneficial arthropods may be packaged in containers with a prescribed number of beneficial insects per volume of carrier such as bran or vermiculite. A benefit of this invention is the precise delivery of the prescribed number of beneficial insects to each plant while minimizing waste.

A controlled environment for growing plants includes, but is not limited to a greenhouse, shadehouse, hoophouse, growth chamber, and an integrated agriculture building. Plant growth variables typically managed in a controlled environment include, but are not limited to, some or all of temperature (air, nutrient solution, root-zone), humidity (such as % relative humidity), carbon dioxide (CO2), light (intensity, spectrum, interval), nutrient concentration (PPM, EC), and nutrient pH (acidity).

Examples of beneficial arthropods that may be used in a controlled environment are (predatory) mites, spiders, parasitic wasps, midges, hoover flies, orius (minute-pirate bug), and assassin-bugs. As used herein, an arthropod is an invertebrate animal having an exoskeleton (external skeleton), a segmented body, and paired jointed appendages. Arthropods include insects, arachnids, myriapods, and crustaceans.

In one embodiment, a device for dispersing beneficial arthropods is provided, wherein the device uses forced gas flow to transport the beneficial arthropods. The forced gas flow pressure may be created by either positive or negative pressure. In one embodiment, positive pressure is used to propel the beneficial arthropods from a moveable container into a transport tube. In one embodiment, negative pressure, such as a vacuum or partial vacuum is used. The negative pressure may be created from a vacuum generator positioned on the transport tube. The moveable container may be filled with a measured quantity of beneficial arthropods positioned on an air permeable surface with an air inlet below the air permeable surface. The forced gas flow system may be a pneumatic system.

In one embodiment, the moveable container may automatically obtain a measured quantity of beneficial arthropods from a storage container, wherein the beneficial arthropods within the storage container may be maintained at a temperature between 35-55 degrees Fahrenheit, or between 43-47 degrees Fahrenheit. The moveable container may be adjusted for speed to obtain the measured quantity of beneficial arthropods per unit of area applied. For example, doses of beneficial arthropods may be delivered at regular (or irregular) intervals of seconds or minutes to allow for the device or plants to be in position for the next successive application.

In one embodiment, a mechanical transfer device, such as a moveable container, is used to transfer the beneficial arthropods from a position located underneath the storage container to a position located proximal to the pneumatic pressure, such that the pneumatic pressure propels the beneficial arthropods into the tubing. The pneumatic pressure may be either positive or negative pressure, and may be located above or below the transfer device. Pneumatic pressure may be obtained from a portable or stationary cylinder with compressed air or other gas, a battery operated compressor, a liquid propane powered air compressor or any other means known in the art.

In some cases, multiple dispersion points may be needed. In one embodiment, a plurality of such devices are arranged in a configuration to enable multiple storage containers to each feed into its own moveable container, which each feed into a transport tube. In another embodiment, a plurality of moveable containers may be operably connected to a single storage container, with each moveable container transferring the beneficial arthropods from that container into a separate transport tube. This configuration avoids the need to split the beneficial arthropods as they are transported, which simplifies the flow dynamics of the beneficial arthropods, and ensures that the complete dosage of beneficial arthropods reaches the dispersion point.

In another embodiment, the device for dispersing beneficial arthropods comprises a temperature controlled storage container, regardless of how the beneficial arthropods are transported. The temperature may be controlled by a cooling coil. In one embodiment, the temperature may be controlled by location, since the device, by virtue of the flow of beneficial arthropods through a transport tube of a length far enough to travel long distances (e.g. greater than 10 meters, greater than 20 meters, greater than 30 meters, greater than 40 meters, greater than 50 meters, etc.) enables the storage of the beneficial arthropods in a separate location from the dispersion point of the beneficial arthropods. In one embodiment, the temperature controlled storage container is located in a portion of a controlled environment with a temperature controlled between 35-60 degrees Fahrenheit, and the dispersion point is located in a portion of the controlled environment with a temperature controlled above 60 degrees Fahrenheit. In one embodiment, the device stores the beneficial arthropods at a temperature range between and including 43 to 47 degrees Fahrenheit. Temperature of the storage container may be passively controlled, such as by insulation around the container or a within double wall insulated or vacuum sealed design. If the container will be stored in a field, the container may be designed to maintain the desired temperature range for an outdoor storage period of about 6-12 hours. In one embodiment, the storage container may fit within the application device in a modular fashion, thereby enabling the rapid replacement of an empty storage container, and optionally, the packaging, transport and delivery of such beneficial arthropods within such storage container. This modular design may take various forms, such as a cartridge or other container structure that is easily attached and unattached (removably connected) from the operational components of the device.

In one embodiment, the device further comprises a transport system, such as a transport tube, that uses pneumatic pressure integrated within the transport system to propel the beneficial arthropods. In one embodiment, a vacuum is generated to transport the beneficial arthropods from the moveable container into the transport tube.

In one embodiment, the device comprises a dispersion tower that is automatically adjusted based on the height of the plants passing under the dispersion tower. Alternatively, or in addition, the dispersion point may be adjusted based on the height of the plants passing under the dispersion tower.

In one embodiment, the temperature controlled storage container comprises an agitation device. The agitation device may be an auger or other mechanical mixing device. Optionally, gas pressure may be used to agitate the beneficial arthropods within the media and to break up any bridges or clumps that may form.

In one embodiment, a method is provided for dispersing beneficial arthropods on plants, comprising storing the beneficial arthropods in a storage container, wherein the storage container is connected to a moveable container, the moveable container transfers the beneficial arthropods to a transport tube, and wherein pneumatic pressure is used to transport the beneficial arthropods through the tube and onto the plants. In one embodiment, negative pressure created by a vacuum generator is used to transport the beneficial arthropods into the transport tube.

### BRIEF DESCRIPTION OF THE DRAWINGS

FIG. 1 shows an overview of one embodiment of the device, with a moveable container that gathers a specific quantity of beneficial arthropods from a storage container and can be moved to a second position in which the beneficial arthropods may be delivered into a transport tube.

FIG. 2 shows a cross sectional overview of one embodiment of the device, with a storage container and a moveable container that gathers a specific quantity of beneficial arthropods from a storage container and can be moved to a second position in which the beneficial arthropods may be delivered into a transport tube.

FIG. 3 shows a close up of a cross section of one embodiment of the device, showing the moveable container in more detail, wherein the moveable container is positioned in a manner to collect beneficial arthropods from the storage container.

FIG. 4 shows a close up of a cross section of one embodiment of the device, showing the moveable container in more detail, wherein the moveable container is positioned in a manner that delivers the beneficial arthropods to a transport tube.

FIG. 5 shows one embodiment of the dispersion tower, with the dispersion points positioned to deliver the beneficial arthropods above the canopy of the plants.

FIG. 6 shows one embodiment of the device mounted on a boom. The boom may be stationary or mobile.

FIG. 7 shows one embodiment of the device positioned on a mobile system that travels on rails or wheels between rows of plant, with the beneficial arthropods applied below the canopy of the plants.

FIG. 8 shows the device of FIG. 7 in a horizontal configuration, useful for traveling between rows of younger or lower growing plants and applying the beneficial arthropods over the top of the plants.

FIG. 9 shows one embodiment of the device in a spray boom configuration mounted on mobile farm equipment, such as a high clearance tractor or sprayer. This configuration is useful for applying the beneficial arthropods outdoors in fields to row crops such as tomatoes and strawberries.

### DETAILED DESCRIPTION OF THE INVENTION

The present embodiments described herein provide a device and method for distributing beneficial arthropods to the top portion of a plant in a manner that minimizes waste, maximizes ease of use, and preserves the life and viability of the beneficial arthropods. Embodiments of the invention may also be positioned to disperse the beneficial arthropods under the canopy of plants in situations where the fruit, flower or other plant parts located at the top of the canopy are desired for commerce or further processing, and need to be kept free of arthropods.

In several embodiments, further measures are taken to make the distribution of the beneficial arthropods less labor intensive and/or more effective than known methods, and to finely calibrate the amount of beneficial arthropods delivered to the plants. Easy loading and maintaining the arthropods in a healthy living state are also aspects of some embodiments.

In one embodiment, an amount of useful arthropods is provided in a storage container that may be remote from all or part of the dispersing device. The container may be in a controlled climate cooled to a suitable temperature for storing the beneficial arthropods, such as between 35-60 degrees Fahrenheit, between 35-55 degrees Fahrenheit, between 40-50 degrees Fahrenheit, or between 43-47 degrees Fahrenheit. Alternatively, or in addition, the beneficial arthropod storage container comprises a cooling system to maintain the stored beneficial arthropods at a desired temperature within any of the ranges stated above. As used herein, the term “temperature controlled storage container” refers to a beneficial arthropod device or system that utilizes either or both of location and a cooling system to maintain a desired temperature in the beneficial arthropod storage container.

In one embodiment, the storage container is suitable for holding the beneficial arthropods and a carrier. The storage container may be a first cylindrical tube, and optionally, may have secondary cylindrical tube that serves as a loading point for the beneficial arthropods and a carrier. The first cylindrical tube may have a central cavity comprising an agitation device to ensure that the beneficial arthropods are, and remain, evenly dispersed within the carrier and throughout the storage container. In the embodiment shown, the agitation device is a shaft that travels the length of the tube with interspersed loops or paddles to slowly and gently circulate the arthropod and carrier mixture. An auger or screw conveyor or similar agitation device may be used to slowly circulate the mixture. This prevents the beneficial arthropods from aggregating in an uneven manner throughout the mixture.

The beneficial arthropods may be provided on their own, or more typically, in combination with a carrier. When the terms “beneficial arthropods” or “arthropods” are used, these terms also encompass the combination with a carrier material. Beneficial arthropods encompass all life stages, inclusive of eggs, nymphs (as far as these occur in a certain species), pupae (as far as these occur in a certain species), and adults of for example, parasite wasps and assassin-bugs and mites, such as predatory mites, for example phytoseiidae, such as described by De Moraes et al. (De Moraes, G. J., J. A. McMurtry, H. A. Denmark & C B. Campos (2004). A revised catalog of the mite family Phytoseiidae. Magnolia Press Auckland New Zealand). The term beneficial arthropods also encompass other arthropods which may be used in biological pest destruction, and when an arthropod has a suitable size and/or form and/or mass to be distributed by means of blowing it can be distributed by using the method according to the invention. The skilled person will be able to determine whether the arthropod is suitable for distribution (dispersion) by means of blowing. Examples of carriers, that may be used in blowing, are bran, sawdust, vermiculite and the like.

The storage container may end in a hopper that reduces through a funnel shaped portion to a narrow loading point for partial or total filling of a moveable container. When located under the hopper, the moveable container is filed to a desired level with the beneficial arthropod. The movable container is then moved to a second position where a forced gas flow system, such as a pneumatic system, may be activated to transport the beneficial arthropods through a tube into the greenhouse or other desired location. The compressed gas used in the pneumatic system may be atmospheric air, carbon dioxide, or a mixture of atmospheric air with carbon dioxide.

The storage container may be cooled by any number of methods known to one of ordinary skill in the art, such as chilled air, a water chiller or an air conditioner condenser. For example, chilled air may be provided to the interior of the storage container, such as through a chilled air intake. A thermocouple may be placed inside the storage container to control the flow of chilled air to obtain a desired temperature. The temperature control of the storage container may be operably connected to a controlled environment automation system, so that the temperature of the storage container may be controlled through a central controlled environment automation system.

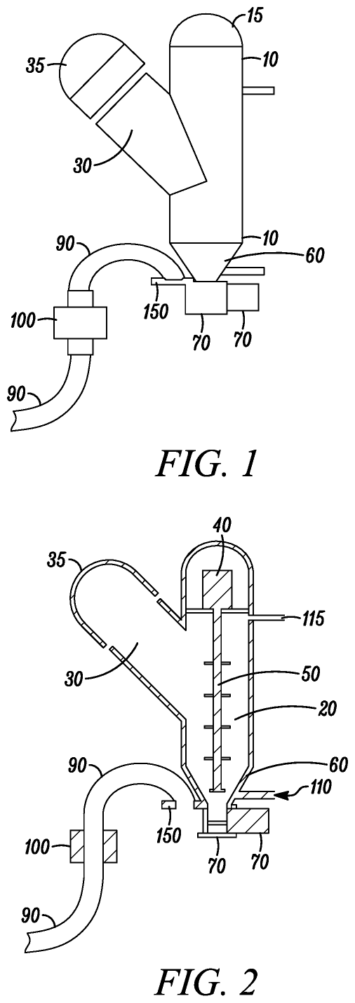

Forced air may be used to draw the beneficial arthropods from the moveable container into a transport tube. In one embodiment, negative pressure is used. In this embodiment, a vacuum generator may be positioned upstream from the transport tube, which vacuum generator allows the clear passage of the beneficial arthropods through the vacuum generator portion of the tubing. For example, in the embodiment shown in FIGS. 1 and 2, a straight-line vacuum generator is used to allow the beneficial arthropods to flow through the vacuum generator and to be transferred in a relatively undisturbed manner from the negative pressure environment preceding the vacuum generator into the positive pressure environment exiting the vacuum generator. This laminar flow transition avoids the turbulence that is often a component of fan based system. The vacuum generator may be a part of a pneumatic logic system.

Pressurized gas is fed into the vacuum generator to create a flow rate optimized for the parameters of the system, such as the tube length and number of turns. In the embodiment shown, with 1 inch internal diameter tubing and a tube length of about 20 to 35 feet, a flow rate of 31 meters per second was the optimal rate to propel the beneficial arthropods through the tubing and out of the spray heads. The flow rate may be optimized for the specific needs of the system to a rate that is sufficient to propel the beneficial arthropod and carrier through the tube and, optionally, up to the dispersion point with appropriate force for dispersal. The rate of flow will typically be within the range of 5 meters per second to about 40 meters per second.

To avoid uneven particle distribution through junctions in the tubing, and therefore potentially unequal particle distribution at the dispersion points, a parallel system was designed, with dual storage containers, dual hoppers, dual moveable containers, dual transport tube lines, and dual vacuum generators. For additional dispersion points, additional systems could be added. By setting equal timing of the two systems and equal airflow rates created by the vacuum generators, the dispersion of the beneficial arthropods can be equally timed. An alternative method of avoiding junctions in the transport tubing is to add duplicative systems at the airlock created at the moveable container, so that multiple but equal amounts of beneficial arthropods each enter a dedicated transport tubing system, which embodiment will also allow for equal dispersion of beneficial arthropods at multiple dispersion points without the use of junctions in the tubing. Of course, it is also possible, if needed, to create junctions in the tubing to multiple dispersion points, and to minimize differential effects at the junction using an air flow splitter, air flow manifold, air flow diverter, or other methods known in the art.

The forced gas flow should be understood to be a gas flow which is forcefully blown and/or directed in a particular direction. The gas may be a compressed gas, such as atmospheric air, carbon dioxide, or a mixture of atmospheric air and carbon dioxide. The beneficial arthropods may be guided mechanically or under the influence of gravity into the forced gas flow. In the embodiment shown, a vacuum is formed when the negative pressure tube comes into proximity with the fill portion of the moveable container. Alternatively, a closed airlock may be formed when the moveable container holding the beneficial arthropods is moved in line with the tubes, and the negative pressure may be activated after the airlock is sealed. Positive pressure may also be used by positioning the vacuum generator in a position, such as proximal to the moveable container, so that positive air pressure is used to propel the beneficial arthropods out of the moveable container and into the transport tube. Positive pressure obtained directly from the forced gas flow without the use of a vacuum generator may also be used.

The forced gas flow may be generated continuously or pulsating. A gas displacer should be understood to be a device suitable for displacing gas, for example by creating pressure differences. The gas displacer used may be made of known means, such as for example rotors (inclusive propeller), of various designs, such as two, three or multiple bladed rotors (inclusive propellers), turbines, or gas containers with a pressurized gas.

The moveable container may be transferred between the fill and delivery position by a pneumatic mechanism, although any suitable mechanism may be used. The back pressure of gas from this transfer may be reused and fed into the hopper to break up any blocking bridge structures that may form as the beneficial arthropods and carrier material pass through the hopper, or if needed, at other points in the storage or transfer of the beneficial arthropods and carrier material.

In one embodiment of the moveable container, the beneficial arthropods in the movable container are carried upward through the top of the moveable container into the transport tube using negative pressure, as described above. In this embodiment, the moveable container is a cup shaped design that supports the beneficial arthropods upon an air permeable surface. In another embodiment, the movable container is a cylinder without a bottom portion, which when moved to a transport position, releases the beneficial arthropods through the bottom and into the transport tube, in which case a diverter may be used to minimize the impact on the beneficial arthropods as they enter the stream of air or other gas.

The moveable container, or a plurality of moveable containers may be actuated between a fill position and a transport position by any number of methods and mechanical transfer devices known to one of skill in the art, including but not limited to use of a retractable arm, a piston, a carousel, or an auger. Each device may be powered pneumatically, electrically or by other means.

The transport tube leads into the greenhouse to an application nozzle or dispersion point. It has been found that tubing with a smooth internal lining provides the best results. A flow sensor, such as a fiber optic flow sensor, may be positioned on the device at any point where desired to detect flow of the beneficial arthropods. One position for a flow sensor is at the point where the beneficial arthropods enter the transport tube.

In some embodiments, it may be desired to have an operator manually spray the plants using the transport tube. In some embodiments, the application nozzle is positioned in a dispersion tower, and positioned to spray the beneficial arthropods and carrier over the top of a plant or tray of plants. For example, if moveable trays are used, the beneficial arthropods may be sprayed over the top of the movable tray of plants as the plants pass under the dispersion tower. The height of the application nozzle may be manually or automatically adjusted based on the height and types of the plants passing underneath, and the timing of the application of the beneficial arthropods may be adjusted to match the speed of the plants being conveyed under the dispersion points. The dispersion point may terminate in a spray head to allow for equal dispersion of the beneficial arthropods.

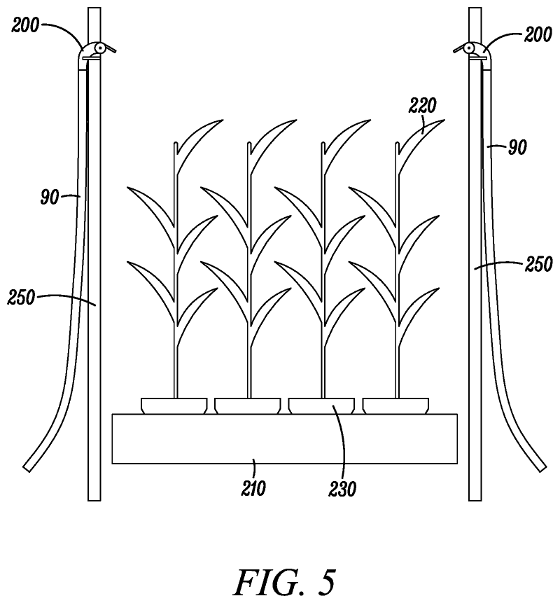

In some embodiments, multiple spray heads may be desirable to create an even coating over the top of the plants. This top placement is desirable for crops such as corn and soybean, because beneficial arthropods do not tend to travel long distances and generally prefer nesting in the crevice between the upper portion of the leaf and the plant stem. For example, the embodiment shown in FIG. 5 is a dual system that works in parallel, with two spray heads on opposite ends of a double stanchion tower that each spray beneficial arthropods as the plant tray is moved under the tower. Each tube may be separately fed in parallel by its own cylinder, as described above.

In other embodiments, existing features present in a controlled environment, or on a piece of field equipment, may be utilized as a support for the transfer tube or tubes and a dispersion point for the beneficial arthropods. In a controlled environment or on field equipment, features such as a watering boom, a fertigation boom, or a moveable plant monitoring or imaging system that travels over or through the canopy may be used. The device or multiple devices may also be directly mounted on a boom. For a boom traveling over the canopy of plants, whether in a field or a controlled environment, gravity instead of a vacuum generator may be used to disperse the beneficial arthropods on to the plant canopy. The number of devices may match the number of rows of plants, thereby providing a precise dose of beneficial arthropods to the top of each plant. Alternatively, the boom may comprise one or more devices positioned to evenly disperse beneficial arthropods over all or part of the plant canopy.

In some controlled environments, such as those used for vegetable production, a mobile sprayer on wheels and/or rails may be utilized to travel through rows of plants to deliver chemicals or fertilizer. The beneficial arthropod delivery device or system may be adapted for use with such sprayer, or as an attachment added to such device. For track or rail driven sprayers, the system or device provided herein may be adapted to be conveyed on the same track or rail used for the sprayers.

FIG. 1 shows an overview of one embodiment of the device. In this embodiment, storage container (10) extends along the points shown. A motor housing (15) is located above the storage container (10). The storage container (10) may be temperature controlled. Beneficial arthropods may be added to the storage container (10) through a fill tube (30) covered by a removable fill cap (35).

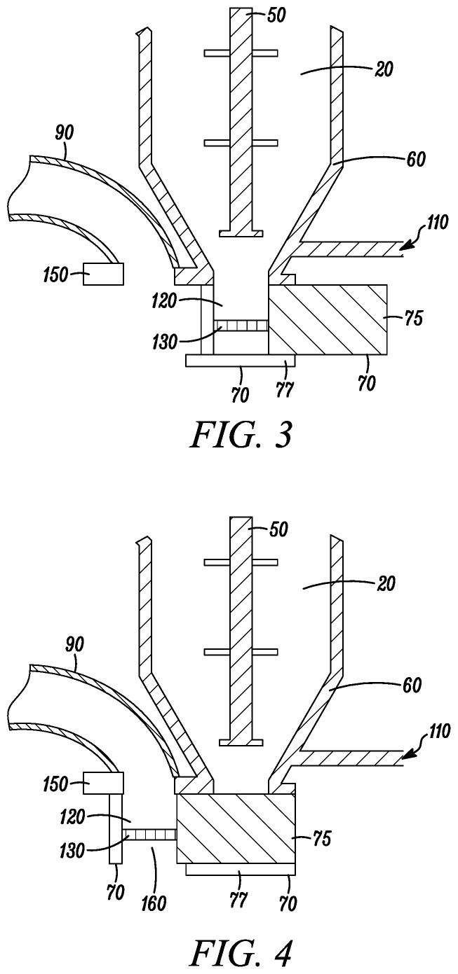

FIG. 2 shows a cross sectional overview of one embodiment of the device comprising a temperature controlled storage container (10), with a motor (40) connected to an agitation device (50) that runs through the central cavity (20) of the storage container (10). The agitation device (50) gently agitates the beneficial arthropods to keep them equally dispersed throughout the storage container (10). The storage container is positioned on a hopper portion (60) that serves as a funnel to direct the beneficial arthropods into the moveable container (70). The moveable container comprises a fill space (120) and a guide block (75), which is positioned on a base plate (77). See FIGS. 3 and 4 for reference. The moveable container may be adjusted in position between a fill position, where the moveable container (70) is positioned directly underneath the hopper (60), and a transport position, where the beneficial arthropods may be transferred to a transport tube (90) for transport to the dispersal point in the controlled environment. The guide block (75) moves along with the fill space (120) and air permeable surface (130) to position the beneficial arthropods under the transport tube (90), while the base plate (77) remains in a stationary position. A vacuum generator (100) may be positioned in the transport tube. A pneumatic source (not shown) may be connected to the vacuum generator (100) to create a jet of airflow toward the dispersal point and negative pressure in the transport tube (90) between the moveable container (70) and vacuum generator (100).

A bridging breakup intake (110) may be positioned in the hopper, so that a pneumatic burst of gas may be used to breakup bridges of beneficial arthropod material that may build up and block the flow or beneficial arthropods through the hopper. In one embodiment, a chilled air intake (115), may be used with chilled air to cool the central cavity (20) of the temperature controlled storage container (10).

FIG. 3 shows a close up cross section of one embodiment of the device comprising the moveable container (70) positioned in a manner to collect beneficial arthropods from the hopper (60). Beneficial arthropods sufficient to fill the fill space (120) of the moveable container are deposited. As described above, a pneumatic burst of gas through the bridging breakup intake (110) may be used to breakup blocking structures of beneficial arthropods to ensure that a sufficient amount of beneficial arthropods are deposited through the hopper (60) to fill the fill space of the moveable container (120) to the desired level. The beneficial arthropods rest on an air permeable surface (130) that has air perforations large enough to allow the air to flow through, but small enough to prevent the beneficial arthropods, including any carrier material, from passing through. A flow sensor, such as an optic flow detector, may be positioned on the device to verify that the beneficial arthropods have properly flowed into and through the transport tube. Some possible locations for the flow sensor are at flow sensor location (150) and/or at or near dispersal point (200) shown in FIG. 5.

FIG. 4 shows a close up cross section of one embodiment of the device comprising the moveable container (70) positioned in a manner that delivers the beneficial arthropods to a transport tube (90). The moveable container (70) has shifted in position in comparison to FIG. 3. In the embodiment represented by FIG. 4, pneumatic pressure was used to engage a piston to move the cassette from the position shown in FIG. 3 to the position shown in FIG. 4, however any mechanical device may be used, including but not limited to an electric motor. In this position, the air permeable surface (130) is positioned over vacuum air intake (160). When negative pressure is created in the transport tube (90), the vacuum created pulls air up through the air intake (160), through the air permeable surface (130), and the air and beneficial arthropods are drawn into the vacuum tube (90) and through the tube to the dispersal point (200), as is shown in FIG. 5.

FIG. 5 shows an embodiment of the dispersion tower portion of the device, with the dispersion points positioned to deliver the beneficial arthropods above the canopy of the plants. A moveable tray of plants (210) is positioned below the dispersion points at spray heads (200). A burst of beneficial arthropods is released from the spray heads (200), and the tray (210) of plants (220) continues to move past the spray heads (200). Once untreated plants, from the same or a new tray is positioned under the spray heads (200), a new burst of beneficial arthropods is applied to the canopy of the untreated plants.

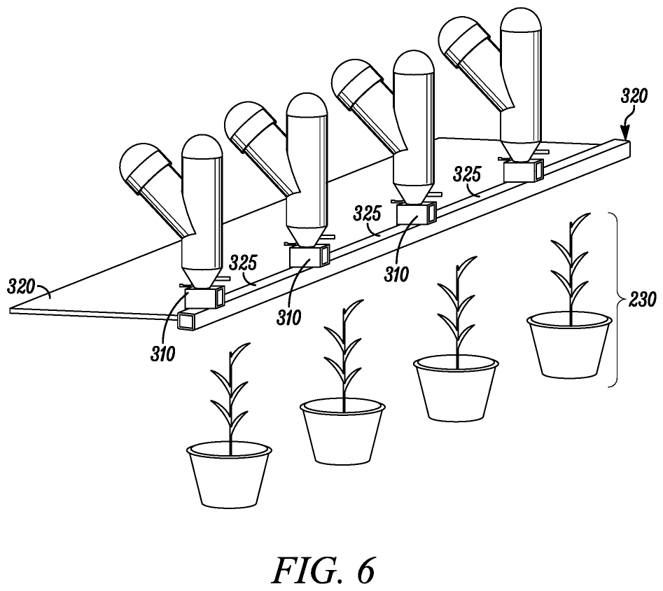

FIG. 6 shows a boom (300) mounted system with multiple devices. In this embodiment, the boom (300) and devices are positioned to disperse the beneficial arthropods over the top of the plant or plants. No vacuum generator is required in the embodiment shown because the boom may be moveably positioned over the plant canopy. An input source of forced gas flow (320) may be used to propel the beneficial arthropods from the moveable container through an output port (310) and over the top of the plant canopy. Alternatively, the moveable container may be powered by an electrical source, and gravity and/or an electrical fan may be used to disperse the beneficial arthropods from the output port (310) over the top of the plants (230). The input source of forced gas flow (320) may be connected to each device either in parallel (not shown) or in series, via forced gas conveyance tubing (325).

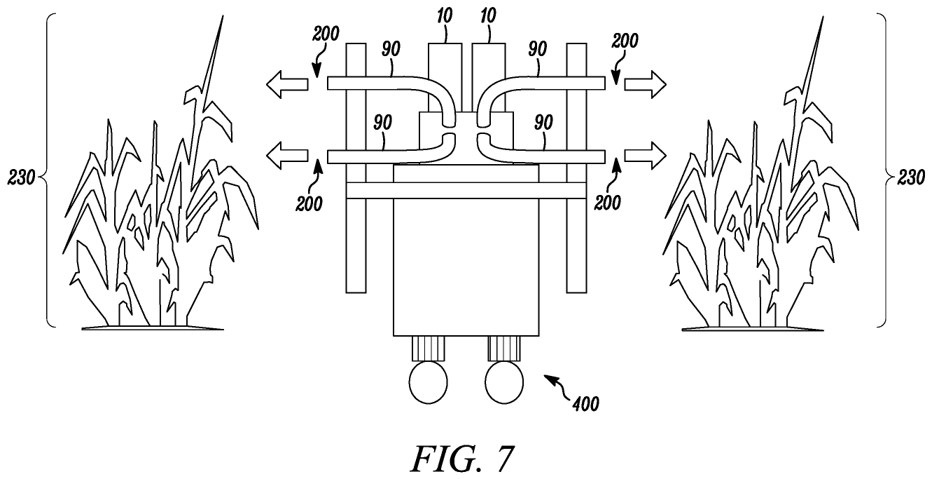

FIG. 7 shows an adaptation of the device to a mobile system that travels on rails or wheels (400) between rows of plant. Existing pipes, such as steam pipes, may be used as rails for the mobile system. In the embodiment shown in this figure, the temperature controlled storage container (10) is positioned on top of the device for easy refill or cartridge exchange when empty. This vertical configuration of the device would be useful for taller plants such as tomatoes, cucumbers and peppers.

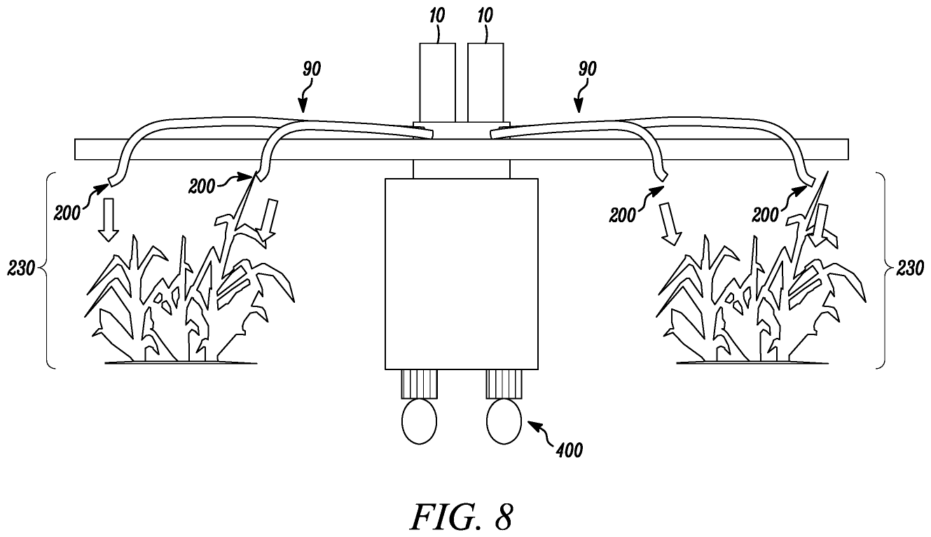

FIG. 8 shows the device of FIG. 7 in a horizontal configuration that would be useful for traveling between rows of younger or lower growing plants.

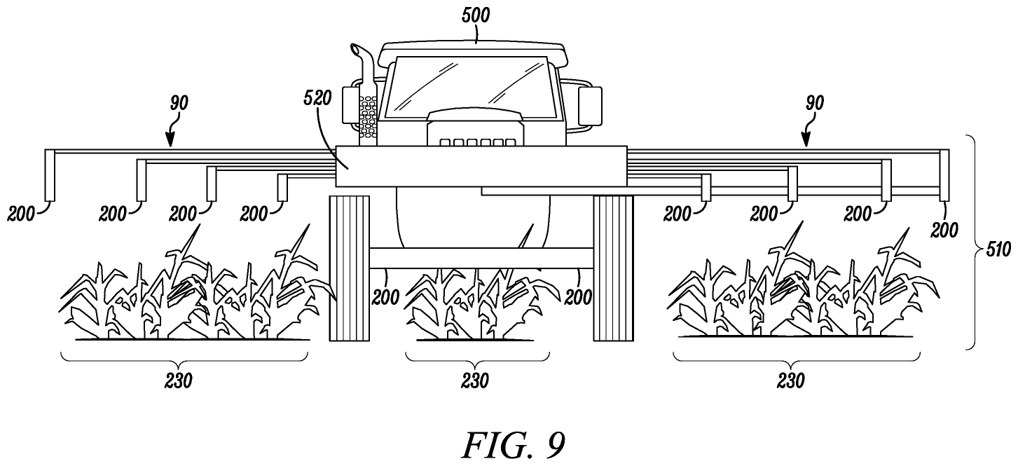

FIG. 9 shows the device in a spray boom configuration mounted on the spray boom (510) of a piece of mobile farm equipment (500), such as a high clearance tractor or sprayer. This configuration is useful for applying the beneficial arthropods outdoors in fields to row crops such as tomatoes and strawberries. The device may be housed in the central portion (520) of the spray boom (510).

The invention further relates to methods of distributing beneficial arthropods with a device suitable for performing the above described method. The scope of the invention is not limited by the described methods and embodiment, but also contains embodiments obvious to a person skilled in the art.

What is claimed is:

1. A device that disperses a measured quantity of beneficial arthropods in rapid succession.

2. The device of claim 1, wherein the device comprises a moveable container which may be positioned in a fill position and a dispersion position, and wherein the measured quantity of beneficial arthropods is deposited into the moveable container when in the fill position, and such measured quantity of beneficial arthropods is dispersed from the device when the movable container has been placed in the dispersion position.

3. The device of claim 1, wherein negative pressure is utilized to transport the measured quantity of beneficial arthropods into a transport tube.

4. The device of claim 3, wherein the negative pressure is created from a vacuum generator positioned on the transport tube.

5. The device of claim 2, wherein the moveable container comprises an air permeable surface on which the measured quantity of beneficial arthropods is positioned prior to application.

6. The device of claim 5, wherein the moveable container is transferred to a location with an air intake below the air permeable surface.

7. The device of claim 2, wherein the moveable container automatically obtains a measured quantity of beneficial arthropods from a storage container, wherein the beneficial arthropods within the storage container are maintained at a temperature between 35-55 degrees Fahrenheit.

8. The device of claim 7, wherein the beneficial arthropods within the storage container are maintained at a temperature between 43-47 degrees Fahrenheit.

9. The device of claim 2, wherein pneumatic pressure is used to transfer the moveable container between the fill position and the dispersion position.

10. The device of claim 1 arranged in a configuration with a plurality of such devices.

11. The device of claim 2, further comprising a plurality of moveable containers, wherein each moveable container transfers the beneficial arthropods from that container into a separate transport tube.

12. The device of claim 11, wherein each transport tube leads to a single dispersion point.

13. The device of claim 1, wherein the beneficial arthropods are transported to a dispersion point located above the plant canopy.

14. The device of claim 1, wherein the beneficial arthropods are transported to a dispersion point located below the plant canopy.

15. The device of claim 1, wherein a dispersion point of the transport tube is automatically adjusted based on the height of the plants.

16. A device for dispersing beneficial arthropods, wherein the device comprises a temperature controlled storage container.

17. The device of claim 16, wherein the temperature controlled storage container comprises a cooling coil.

18. The device of claim 16, wherein the temperature controlled storage container is insulated.

19. The device of claim 16, wherein the temperature controlled storage container may be removably connected and reconnected with the portion of the device that disperses the beneficial arthropods.

20. The device of claim 16, wherein the temperature controlled storage container is located in a portion of a controlled environment with a temperature between 35-60 degrees Fahrenheit, and the dispersion point is located in a portion of the controlled environment with a temperature controlled at or above 60 degrees Fahrenheit.

21. The device of claim 16, wherein the temperature controlled storage container comprises an agitation device.

22. A system for dispersing beneficial arthropods on plants comprising at least two components, a first component comprising a storage container, and a second component comprising a device for dispersing the beneficial arthropods obtained from the storage container.

23. The system of claim 22, wherein second component comprises a moveable container that measures a specific quantity of the beneficial arthropods.

24. The system of claim 23, wherein pneumatic pressure is used to drive the moveable container.

25. The system of claim 23, wherein pneumatic pressure is used to propel, or to drive a mechanism that propels, the beneficial arthropods from the movable container to the plants.

26. The system of claim 22, wherein the first component storage container comprises an electric motor that drives an agitation device within the container.

27. The system of claim 22, wherein the first component storage container is temperature controlled.
